(19) United States
(12) Patent Application Publication
(10) Pub. No.: US 2003/0007836 A1
(43) Pub. Date: Jan. 9, 2003

(54) Method for creating custom design interlock

(76) Inventors: Randy Brian Clarke, Perth (CA); Lucie Rolande Parisien, Perth (CA)

Correspondence Address: Randy Brian Clarke, Lucie Rolande Parisien, RPRP#6 Perth, Ontario, CA

(21) Appl. No.: 09/898,865

(22) Filed: Jul. 5, 2001

(51) Int. Cl. B32B 31/00

(52) U.S. Cl. 404/73; 156/250; 156/247

(57) ABSTRACT

A method of manufacturing a covering material for covering a substrate such as ground, a floor, walls or the like, is described wherein the covering material includes a complex visual design. The steps include selecting the design, creating a plurality of adhesive-backed vinyl design sections corresponding to distinct predetermined areas of structure and color of the design and having a predetermined horizontal and vertical orientation and location within the design, marking the design sections to identify the predetermined color, orientation and location, selecting blank elements corresponding in color to the identified colors marked on the design sections, selecting a surface of each blank element to correspond to an upper design surface of a design element, fixing the design sections to the upper design surface of the appropriate corresponding color of blank element, cutting the blank elements to form design elements, wherein the upper design surface of each resulting design element has a plan form shape corresponding to the plan form shape of the affixed design section, preparing background elements having a void sufficient to accommodate the design elements; assembling the design elements into the void in an inter-engaging relationship in accordance with the identified orientations and locations marked on the affixed design sections, and removing the design sections from the design elements.

This invention relates generally to a method for creating a covering material for covering a substrate such as ground, a floor, walls or the like, and in particular to a method for the custom design of an interlocking covering material composed of a plurality of irregularly shaped elements which cooperate to create a visually pleasing effect.

### BACKGROUND OF THE INVENTION

The use of stones and manufactured bricks for covering material such as paving and the like has expanded in the past several years as the result of reduced manufacturing costs and improvements in the strength and durability of the paving units. In a typical installation, a plurality of identical, interlocking units are used to pave an area, each unit having an irregular plan-form shape which is designed to closely engage and interlock with adjacent paving units. When such units are assembled to cover a surface, they cooperate to form a generally flat, continuous ground cover having a repeating visual pattern formed by the joints between the adjacent units.

Normally, the pattern formed by conventional paving units is entirely governed by the plan-form shape and colour of each unit. In some cases, it is possible for the skilled worker to create custom patterns (such as circles, swirls, waves or the like) by shifting or rotating adjacent units with respect to each other and by using different coloured units. These patterns have generally been limited to simple repeating forms. Creating more complex graphic designs and print on paving-stones, brick facades, or floor or wall tiles of wood, plastic, or ceramic, has in the past required the use of pre-cast graphic or alphanumeric patterns, such as those described by Widmer in U.S. Pat. No. 5,249,884, or highly expensive custom work in which the individual pieces are arranged on the job site to create a specific design.

Canadian patent application No. 2,139,006 (Lauzon), which was laid open to the public on Jun. 23, 1996, describes a covering material made up of a plurality of elements, each of which has an arbitrary predetermined shape in plan-form. The elements are shaped and coloured in such a manner that when they are closely inter-engaged, the joints between the elements, often in combination with the colour of the elements, form a complex visually pleasing pattern. The exterior elements of the pattern are designed to interface between the pattern and the surrounding matrix. Although Canadian patent application No. 2,139,006 describes the cutting, shaping and general assembly of the individual elements, it is primarily concerned with single pre-existing designs intended for mass production. There is no discussion, in Canadian patent application No. 2,139,006, of a method for easily and rapidly transferring a complex graphic image onto an arrangement of individual elements wherein the joints between the elements combine with the colour of the elements to reproduce the complex graphic image.

One of the main problems with transferring complex graphic images into an arrangement of closely inter-engaging individual elements that reproduce the graphic image by a combination of the joints between the elements and the colour of the elements, is tracking the individual elements from when the elements are first identified and isolated on the graphic image, through to when those elements are cut from the blank stone or paving material, and finally to their assembly within a surrounding matrix to re-create the desired visual image in the covering material.

Typically, the individual pieces making up the complex graphic image are cut and assembled on the site where they are to be installed into a surrounding matrix. This is usually done by projecting the image onto a wall using an overhead projector to enlarge the image to the desired size. Each element of the image is identified according to its colour and shape and a life-size cardboard template of that element is cut. An outline of the cardboard template is traced onto a paving element of the appropriate size and colour. The paving element is cut along the marked lines and placed directly into its final location within the matrix. These steps are repeated, one element at a time, until all of the elements have been cut and assembled within the surrounding matrix. One of the main disadvantages of this technique is that the elements must be sequentially identified, cut and assembled one at a time. Otherwise, tracking the elements from their location on the image to their corresponding location within the matrix becomes comparable to assembling a jigsaw puzzle. The result is a costly and time consuming process upon which the present invention has improved.

### BRIEF SUMMARY OF THE INVENTION

An object of the present invention, therefore, is to overcome the shortcomings of the current systems by providing a new and improved method for transferring complex graphic images into an arrangement of closely inter-engaging individual elements that reproduce the graphic image by a combination of the joints between the elements and the colour of the elements.

Another object of a preferred embodiment of the present invention is to provide a new and improved method for transferring complex graphic images into an arrangement of closely inter-engaging individual elements that reproduce the graphic image by a combination of the joints between the elements and the colour of the elements that permits the elements to be separately and non-sequentially identified, cut and assembled.

Briefly, these objectives are achieved by the present invention, which provides a method of manufacturing a covering material for covering a substrate, the covering material including a complex visual design, comprising the steps of: selecting the design for the covering material; creating a plurality of design sections, each said design section corresponding to a distinct predetermined area of structure and colour of the design, each said design section having a predetermined orientation and location within the design, and each said design section defining a predetermined plan form shape; marking said design sections to identify said predetermined colour, orientation and location; selecting blank elements of various colours, said colours corresponding to said identified predetermined colours of said design sections, said blank elements having an arbitrary predetermined shape; manufacturing design elements from said blank elements by: selecting a surface of each of said blank elements as defining an upper design surface of each of said design elements; corresponding said identified predetermined colours of said design sections with said corresponding colours of said blank elements and fixing said corresponded design sections to said upper design surfaces of said corresponding colours of said blank elements; and cutting said blank elements to form said design elements, said upper design surfaces of each said resulting design element having a plan form shape corresponding to said plan form shape of said affixed design section; preparing background elements having a void sufficient to accommodate said design elements; assembling said design elements into said void in an inter-engaging relationship in accordance with said identified orientations and locations marked on said affixed design sections; and removing said design sections from said design elements.

In accordance with the objectives of the present invention there is also provided a method of manufacturing a covering material for covering a substrate, the covering material including a complex visual design, comprising the steps of: selecting the design for the covering material; creating a line drawing representative of the design, said line drawing comprising a plurality of design sections, each said design section corresponding to a distinct predetermined area of structure and colour of the design, each said design section having a predetermined orientation and location within the design, and each said design section defining a predetermined plan form shape; marking said design sections to identify said predetermined colour, orientation and location; selecting blank elements of various colours, said colours corresponding to said identified predetermined colours of said design sections, said blank elements having an arbitrary predetermined shape; manufacturing design elements from said blank elements by: selecting a surface of each of said blank elements as defining an upper design surface of each of said design elements; corresponding said identified predetermined colours of said design sections with said corresponding colours of said blank elements and fixing said corresponded design sections to said upper design surfaces of said corresponding colours of said blank elements; and cutting said blank elements to form said design elements, said upper design surfaces of said resulting design elements having a plan form shape corresponding to said plan form shape of said affixed design sections; preparing background elements having a void sufficient to accommodate said design elements; assembling said design elements into said void in an inter-engaging relationship in accordance with said identified orientations and locations marked on said affixed design sections; and removing said design sections from said design elements.

In accordance with the further objectives of the present invention there is provided a method of manufacturing a covering material for covering a substrate, the covering material including a complex visual design, comprising the steps of: selecting the design for the covering material; creating a line drawing representative of the design, said line drawing comprising exterior lines defining a plan form shape of the design, and interior lines, said interior and exterior lines combining to define a plurality of design sections, each of said design sections corresponding to a distinct predetermined area of structure and colour of the design, each of said design sections having a predetermined orientation and location within the design, and each of said design sections defining a predetermined plan form shape; marking said design sections to identify said predetermined colour, orientation and location; arranging onto a support structure a plurality of inter-engaged background elements covering an area sufficient to accommodate the design, said background elements comprising substantially planar, substantially parallel top and bottom surfaces, and one or more background element side surfaces connecting said top and bottom surfaces; marking background cut lines onto said top surfaces of said inter-engaged background elements, said background cut lines corresponding to said exterior perimeter of the design; cutting said background elements along said background cut lines to redefine one or more of said background element side surfaces; removing said cut background elements corresponding to said plan form shape of the design, thereby creating a void within said inter-engaged background elements, said void corresponding to said plan form shape of the design; selecting blank elements of various colours, said colours corresponding to said identified predetermined colours of said design sections, said blank elements having an arbitrary predetermined shape; manufacturing design elements from said blank elements by: selecting a surface of each of said blank elements as defining an upper design surface of each of said design elements; corresponding said identified predetermined colours of said design sections with said corresponding colours of said blank elements and fixing said corresponded design sections to said upper design surfaces of said corresponding colours of said blank elements; and cutting said blank elements to form said design elements, each of said resulting design elements having a base, said base being substantially planar and substantially parallel to said upper design surface, and one or more design element side surfaces, said design element side surfaces being oriented at an acute angle with respect to said base and cooperating to define said upper design surface, said upper design surface having a plan form shape corresponding to said plan form shape of said affixed design section; assembling said design elements into said void in an inter-engaging pattern in accordance with said identified orientations and locations marked on said design sections; and removing said design sections from said design elements.

In accordance with a still further objective of the present invention, there is provided a covering material for covering a substrate, the covering material including a complex visual design, the covering material being produced in accordance with any of the above described methods.

The present invention advantageously provides a method for transferring complex graphic images into covering materials by way of an arrangement of closely inter-engaging individual elements that reproduce the graphic image by a combination of the joints between the elements and the colour of the elements that is less costly and more efficient than currently existing methods. A further advantage of the method of the present invention is that the individual design elements do not have to be identified, cut and assembled in sequential steps, but can be separately and non-sequentially identified, cut and assembled, thus permitting greater flexibility and efficiency in image assembly. A another advantage of the present invention is that the individual elements can be cut and assembled without further reference to the original graphic image used to identify the elements.

Further objects and advantages of the present invention will be apparent from the following description and the appended drawings, wherein preferred embodiments of the invention are clearly described and shown.

### BRIEF DESCRIPTION OF THE DRAWINGS

The present invention will be further understood from the following description with reference to the drawings in which:

FIG. 1 is a top plan view of a covering material constructed in accordance with the method of the present invention, incorporating a tree design;

FIG. 2 is an enlarged view of a segment from the right side of the tree design shown in FIG. 1;

FIG. 3 is a line drawing showing the floral design illustrated in FIG. 1;

FIG. 4 is an enlarged view of a segment from the upper right section of the line drawing shown in FIG. 3;

FIG. 5 in an illustration of a crate used to assemble and ship the covering material of the present invention;

FIG. 6 is an illustration of a fabric lining used to line the crate of FIG. 5;

FIG. 7 shows background elements assembled in the crate of FIG. 5, lined with the fabric of FIG. 6, and from which a void, corresponding to the line drawing of FIG. 3, has been cut;

FIG. 8 is an illustration of a typical saw used in the method of the present invention to cut paving stones or the like;

FIG. 9 is an enlarged view of a segment of the line drawing of FIG. 3 showing a preferred method for marking the areas of the line drawing that correspond to design elements of the covering material;

FIG. 10 is an enlarged view of a segment of the line drawing of FIG. 3 showing an alternative preferred method for marking the areas of the line drawing that correspond to design elements of the covering material;

FIG. 11 is an illustration of a typical blank paving stone from which design elements of the covering material of the present invention are cut;

FIG. 12 is an illustration of a typical resulting design element of the covering material of the present invention following cutting of the blank.

### DETAILED DESCRIPTION OF THE PREFERRED EMBODIMENTS OF THE INVENTION

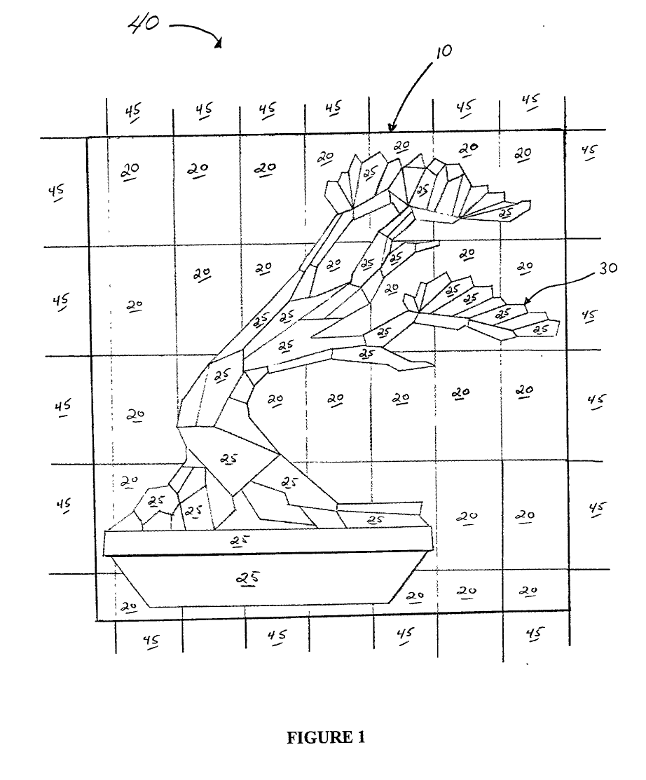

The present invention will now be described in detail as it relates to the particular design shown in FIG. 1, and the method of arranging the elements used to create such design. However, it should be understood that the present invention is in no way restricted to the particular design shown. Those skilled in the art will appreciate that, based on the following teaching, it will be possible to construct an almost limitless variety and range of different graphic designs, limited only by the skills of the designer, the available materials, and the capabilities of the procurable tools. Furthermore, even though the present description focusses on the method for creating a covering material for use as ground cover, the present invention is in no way limited to such use, and may be used for creating a covering material for covering virtually any substrate capable of securely supporting the covering material.

Referring to FIG. 1, a covering material 10 is, in the illustrated case, conveniently comprised of conventional paving bricks or stones. Covering material 10 includes of a plurality background elements 20 and design elements 25 which combine, in plan form, to define a complex graphic design 30 (a tree design in the present case). Covering material 10 is constructed for installation into a surrounding matrix 40 comprised of a plurality of matrix elements 45, which in the illustrated case are also comprised of regularly shaped conventional paving bricks or stones. Before being cut in accordance with the method of the present invention, background elements 20 are generally, but not necessarily, of the same size and shape as matrix elements 45. This permits covering material 10 to be easily integrated into surrounding matrix 40 by engagement of background elements 20 with matrix elements 45. When constructing surrounding matrix 40 the usual practice is to leave a space, corresponding to the exact dimensions of covering material 10, into which covering material 10 can later be inserted upon completion. In this way, covering material 10 can be conveniently constructed off-site and later transported to the work site for installation.

As noted above, the illustrated case, describes a surrounding matrix 40 comprised of conventional paving bricks or stones 45, however, it should be clear to one skilled in the art that surrounding matrix 40 can be almost any material including for example, new or used interlocking paving bricks or stones, concrete, asphalt, wall board, hardwood flooring, stone or marble, or the like.

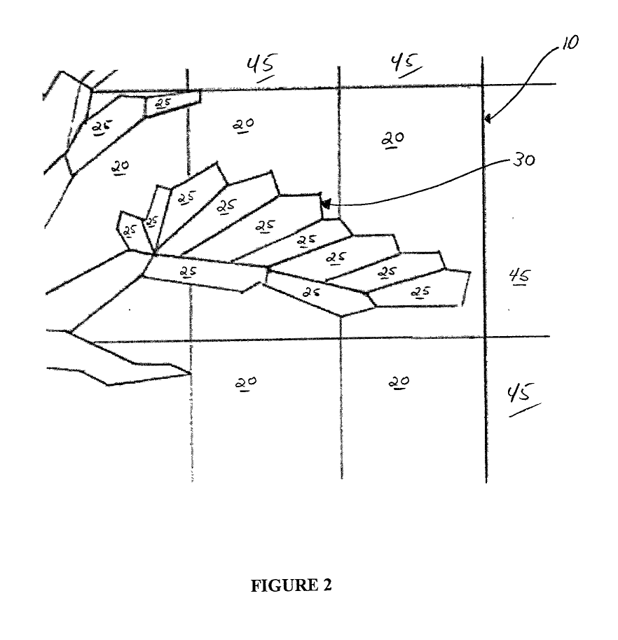

FIG. 2 is an enlarged view of a segment on the right side of the illustration of FIG. 1.

Design 30 is defined by the plan form shape of a plurality of elements 20, 25 assembled in an engaging mosaic-like fashion. Elements 20, and 25 are arranged in a closely fitting, interlocking relationship and in general are constructed so as to minimize the width of any gaps between adjacent elements. As a result, when covering material 10 is used as a part of a ground cover (for example as part of a walk-way or patio), each element 20, 25 is retained in place by gravity and its cooperative (mechanical) engagement with the immediately neighbouring elements. Consequently, the covering material 10 does not require extensive use of bonding agents or grout to retain individual elements in place, as required in conventional tile mosaic patterns. Thus, when used as ground cover, the elements 20, 25 defining design 30 can shift slightly over time, to accommodate ground movement and settlement, without cracking the elements or significantly disrupting design 30. Furthermore, in the event that any elements do crack, replacement of the damaged element can be accomplished without disturbing surrounding elements.

When the covering material 10 is to be used a part of a wall cover, a suitable grout or bonding agent can be used to bond elements 20, 25 together. In this case the covering material 10 can be assembled and permanently bonded to a suitable reinforcing backing, for example reinforced steel mesh embedded in mortar or grout. This arrangement permits the assembled covering material to be supported in a vertical orientation without buckling. However, it will be appreciated that, with this arrangement, replacement of individual elements (should they crack or be damaged) will be very difficult. Accordingly, care must be exercised to ensure that an appropriate grout and reinforcement backing are selected, and that the grout properly fills the spaces between elements 20, 25 so that elements 20, 25 are fully supported.

The applicant's novel method for transferring a complex graphic image into an arrangement of closely inter-engaging individual elements 20,25 that define design 30 in covering material 10 will now be discussed in detail. First, the desired image is selected and preferably scanned using a digital scanning device. This creates a digital representation of the selected image that can be easily manipulated using a graphic design program such as CorelDraw!™. In the method of the present invention, the applicant has found no limitation to the nature or type of original image can be used. For example, photographs of trees and animals, illustrations of cartoon characters, or paintings of buildings and landscape scenery have all been found suitable for reproduction using the applicant's method.

The next step is to input the digital file representing the scanned image into a computer containing a graphic design program such as CorelDraw!™, and to create a line drawing 50, like that shown in FIG. 3. Line drawing 50 is comprised of interior lines 55 and exterior lines 55a. In creating line drawing 50 the graphic artist will seek to outline and isolate areas of different colour, texture and structure on the original image. Each line 55, 55a created by the graphic artist represents a cut-line defining the plan form shape of elements 20, 25 that will eventually be assembled to create design 30 in covering material 10. Outlined areas enclosed by cut lines 55, 55a define sections 96 which have a plan for shape corresponding to the plan-form shapes of design elements 25. Exterior cut lines 55a also define a portion of the plan form shape of background elements 20. The remaining plan form shape of background elements 20 is defined by the factory-cut or cast edges of those elements. A certain degree of artistic skill is required to create line drawing 50 by selecting the most appropriate segmentation of the original image according to colour, texture and structure that will best define design 30.

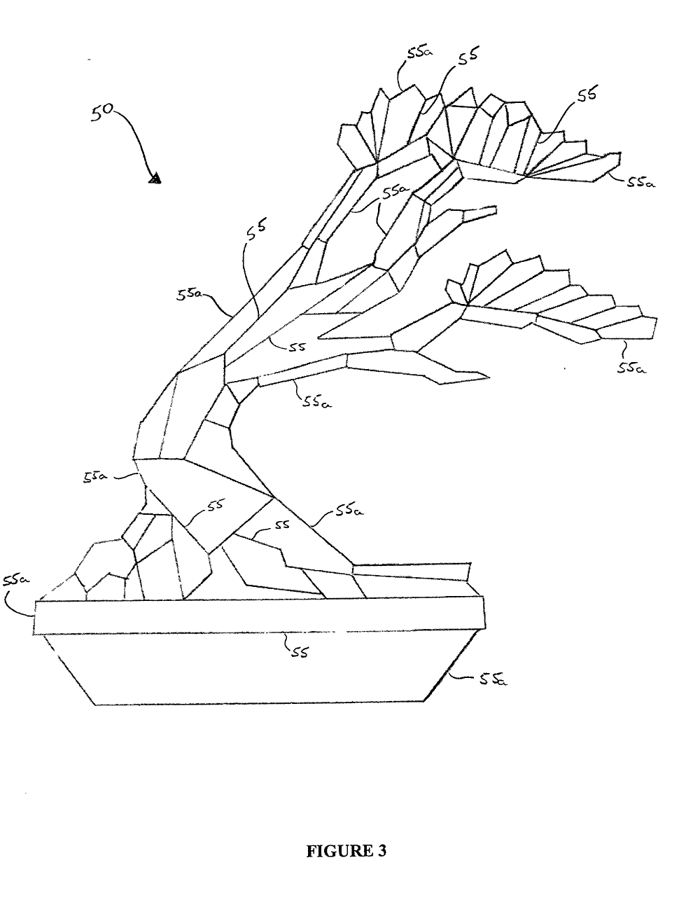

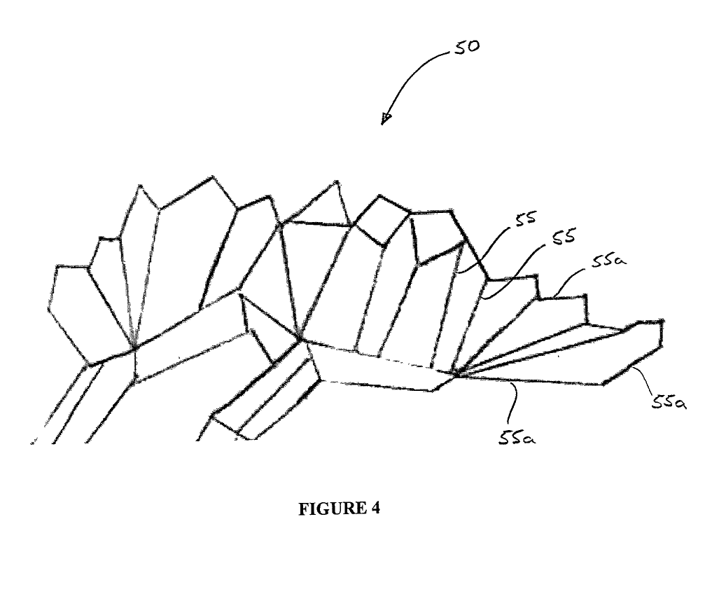

FIG. 4 is an enlarged view of a segment on the upper right side of the illustration of FIG. 3.

Once line drawing 50 is created in the computer, the desired size of covering material 10 is determined and line drawing 50 is enlarged so that it will fit within the area defined by covering material 10. Line drawing 50 is first printed on paper at one-to-one full-size using a printer/plotter. The applicant uses a GSX Plus printer/plotter and accompanying software manufactured by Gerber Scientific Products, Inc., however, it should be evident that any suitable printer/plotter could be used for the task. The printer/plotter used by the applicant is capable of printing on a continuous strip of paper eighteen inches wide. In the event that one dimension of the desired image is greater than eighteen inches, the image is printed in more than one segment on the printer/plotter and the segments are assembled to create full-size reproduction of line drawing 50 on paper. Line drawing 50 is then cut away from the surrounding paper sheet by trimming along exterior cut lines 55a.

Next, a second full-size version of line drawing 50 is produced on a sheet of adhesive backed vinyl using the same printer/plotter used to reproduce the first full-size version of line drawing 50 on paper. The adhesive backed vinyl used by the applicant is of the type that includes a backing sheet to protect the adhesive during transportation and storage. When the vinyl is required to be adhered to an object, the backing sheet is removed by peeling it away from the vinyl to expose the adhesive layer. A suitable vinyl, that comes in a continuous eighteen inch-wide sheet, is manufactured by a company called Avery Dennison and is sold under the trademark QMS. Prior to tracing the second full-size version of line drawing 50 onto vinyl, the pen in the printer/plotter is replaced with a cutting knife which is adjusted so that it cuts through the surface layer of vinyl but does not penetrate the backing sheet. Accordingly, cut lines 55, 55a are reproduced as cut lines in the vinyl and areas enclosed by cut lines 55, 55a correspond to the ultimate plan-form shapes of design elements 25. It is the experience of the applicant that to ensure perfect registration between the first paper version and second vinyl version of line drawing 50, they should each be produced sequentially using the same printer/plotter. If the paper and vinyl versions of line drawing 50 are not precisely the same size, difficulty will be encountered when attempting to assemble design elements 25 together with background elements 20 to produce design 30.

It will be appreciated by one skilled in the art that the above steps could be accomplished using other methods. For example, an overhead projector could be used to enlarge the desired image to the required size and to project it onto a screen or a wall. The paper and vinyl versions of line drawing 50, as describe above, could then be created by manually tracing cut lines 55, 55a, corresponding to areas of different colour, texture and structure, directly onto large sheets of paper or vinyl hung against the wall or screen. The applicant believes, and the reader will readily appreciate, that the method of the present invention as described above is far more efficient and provides for much greater accuracy and precision when creating line drawing 50 from an original image and transferring a full-size, one-to-one reproduction of line drawing 50 to both paper and vinyl.

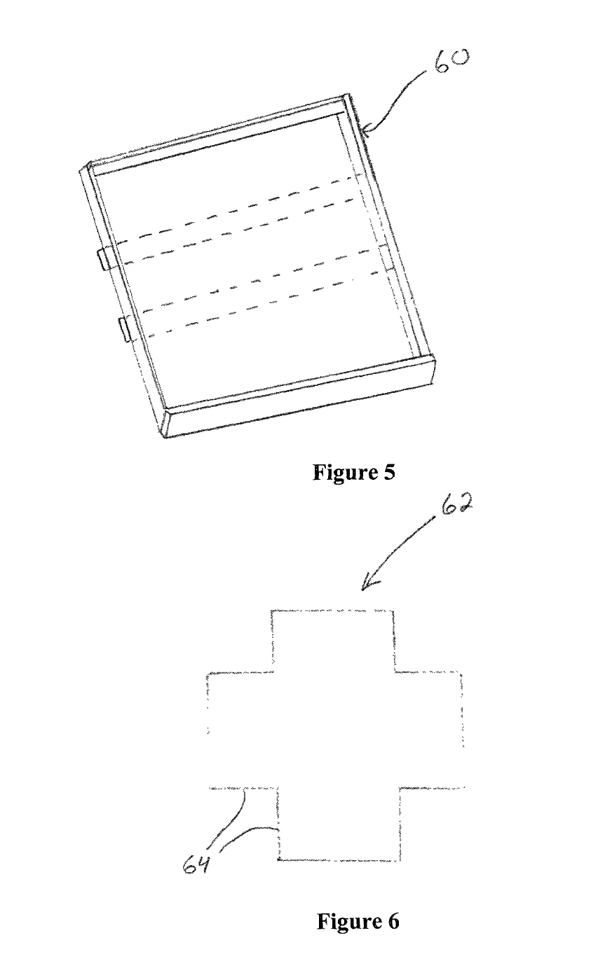

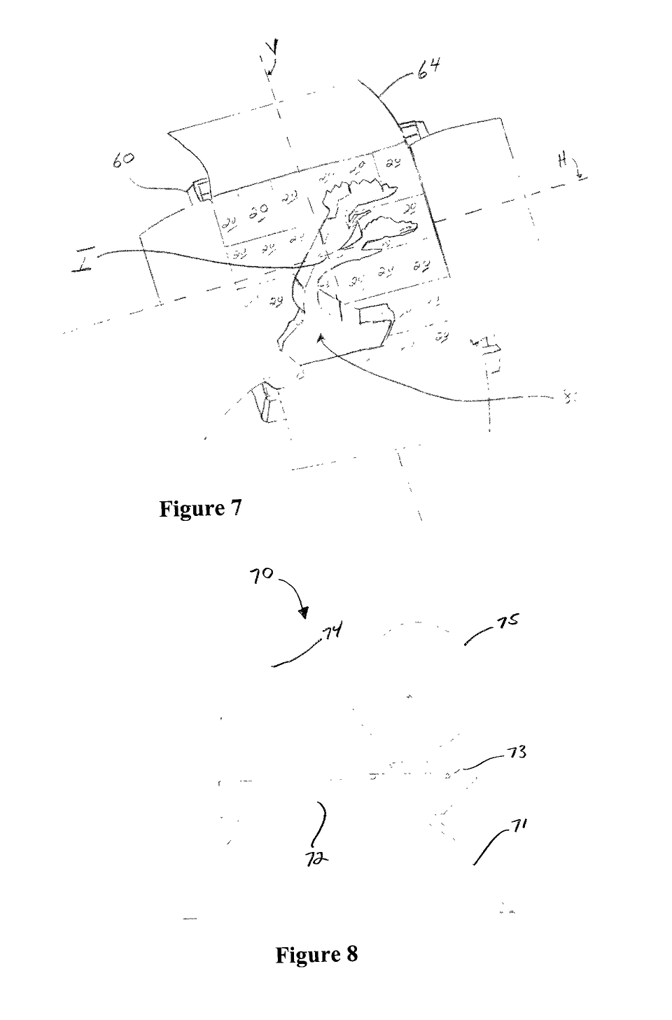

To minimize cost and ensure that covering material 10 is accurately formed, it is often advantageous to cut and assemble background elements 25 and design elements 20 at a remote location from the installation site, perhaps at a factory specially designed for this type of construction. Referring to FIG. 5, a suitable container, such as a wooden crate 60, is constructed to contain background elements 20. The interior dimensions of crate 60 are equal to the desired exterior dimensions of covering material 10. Crate 60 is used to facilitate the assembly of covering material 10 at a remote location and transport to the installation site. As shown in FIGS. 6 and 7, when covering material 10 is to be used as a ground cover, a layer of suitable fabric or paper 62 is used to line the interior of crate 60. Fabric 62 can include flaps 64 which are cut so that they extend beyond the edges of crate 60 and can be folded up to cover and protect the top of covering material 10 during transport. The applicant has found that a tough nylon fabric material called Albany Forming Fabric, manufactured by Albany International Corporation, is most suitable for this purpose, however, those skilled in the art will appreciate that any suitable fabric or paper material could be used.

Referring to FIG. 7, before any of the elements are cut, background elements 20 are arranged to completely fill crate 60. The paper version of line drawing 50 is laid on top of background elements 20 and located in the desired orientation. An outline of line drawing 50 is carefully traced along exterior cut lines 55a onto the surface of background elements 20. Orientation of the image is determined with respect to a horizontal line H and a vertical line V drawn at an angle of 90 degrees to one another through background elements 20. Horizontal line H is generally, but not necessarily, parallel to one of the sides of crate 60. The extension of lines H and V, through intersection point I is marked as a cross on the paper version of line drawing 50. The orientation of the resulting cross is used later when assembling individual design elements 25.

Once exterior cut lines 55a have been marked on the surface of background elements 20, the final plan form shape of background elements 20 can be determined by cutting along these surface markings. Cutting of background elements 20 is accomplished using a circular table saw 70 similar to that shown in FIG. 8. Saw 70 includes a stand 71, a water tank and base 72 supporting a moving material table 73, and a motor 74 used to drive a circular saw blade 75. The applicant has found that a 14 inch diameter, 0.08 inch thick, smooth diamond-edged bonded circular saw blade, operating at 1800 rpm, is useful for cutting most materials from which elements 20 and 25 can be formed, and is most advantageous when the elements are conventional paving brick or stones. Background elements 20 are placed onto moving table 73 and cuts are made by carefully following previously marked cut lines 55a on the surface of background elements 20. The cutting techniques used are identical to those used and described below in respect to the cutting of design elements 25. The resulting background elements 20, minus the cut-away material, are then reassembled in their original location within crate 60 thus forming a void 80. As shown in FIG. 7, void 80 exactly matches the exterior plan form shape of design 30.

It will be understood by those skilled in the art that any suitable saw could be used to cut background elements 20, such as a diamond string or wire saw, a diamond coated band saw, or a high-pressure jet cutting machine. The applicant has found the above-described circular saw to be most advantageous and the least expensive to operate. However, it will be appreciated that the use of a circular saw restricts the plan form shape of design elements 20 and 25 to poly-angular plan form shape having planar side surfaces. Although more expensive, the use of wire saws, band saws and high pressure jet cutters increases flexibility by allowing the plan form shape of the elements to include curved lines. As a further advantage, high pressure jet cutters are frequently computer controlled which permits the elements to be cut with a high degree of accuracy.

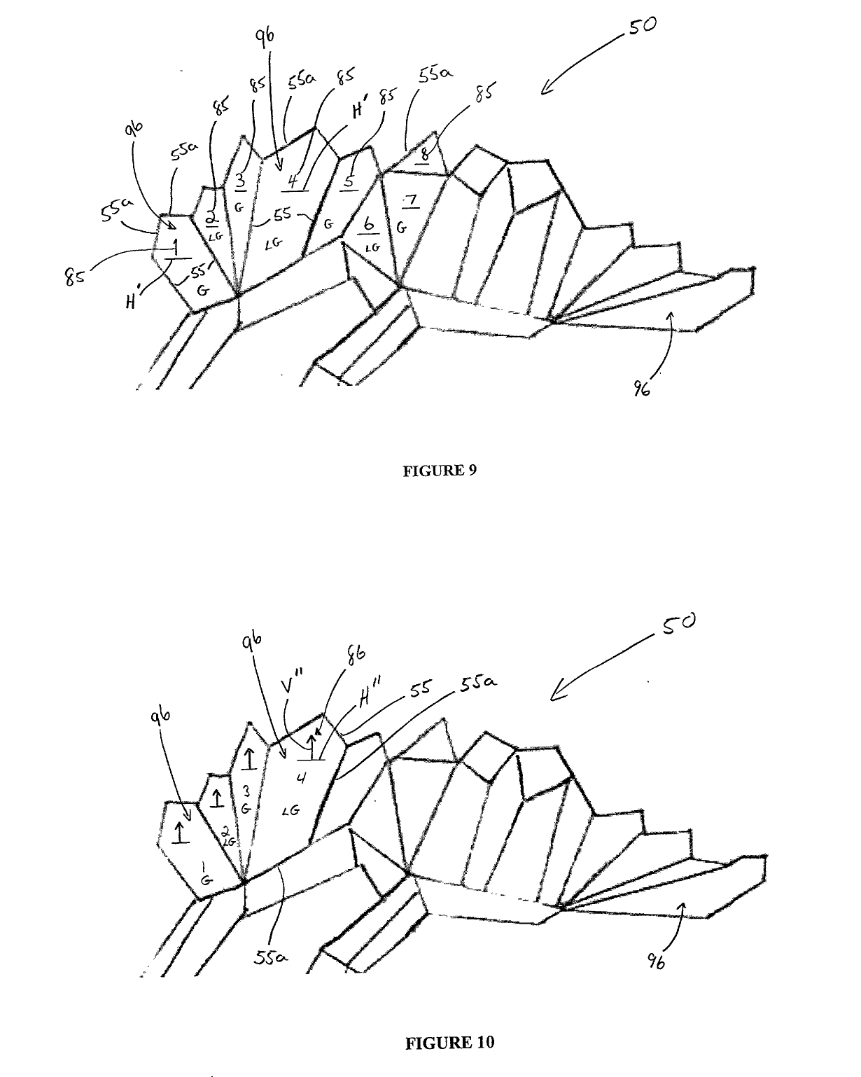

FIG. 9, is an enlarged segment of line drawing 50 and could represent either the first paper or second vinyl versions of line drawing 50. A unique number 85 is placed within each section 96 defined by cut lines 55 and 55a which correspond to the plan form shape of design elements 25. Numbers 85 are marked sequentially proceeding from left to right commencing at the top of line drawing 50 and progressively moving to the bottom in the same manner as one would read a book. In this way, the first section 96, located in the extreme upper left of line drawing 50, will be marked with the lowest number 85 in the sequence and the last section 96, located in the extreme lower right of line drawing 50, will be marked with the highest number 85 in the sequence. Each number 85 is carefully placed within the defined sections 96 and written in a vertical orientation with respect to a baseline H′. Baseline H′ is parallel to horizontal line H that was previously marked on the paper version of line drawing 50 during the marking of background elements 20. The vertical axis of numbers 85 marked within sections 96 is parallel to vertical line V that was marked previously on the paper version of line drawing 50 during the marking of background elements 20. Horizontal line H′ combined with the vertical orientation and sequence of numbers 85 marked within each section 96 is used to assist in locating and orientating the corresponding design element 25 within void 80 during final assembly as described in more detail below.

Also at this stage, each section 96 on the first paper version of line drawing 50, corresponding to the plan form shape of design elements 25, defined by cut lines 55 and 55a, is marked according to the colour of stone that will be used for the corresponding design element 25. In the illustration shown in FIG. 9, the letter G has been used for the colour green, while LG has been used for light green. The particular coding system used will depend on the various colours of stone required and available for best reproducing design 30. It is only necessary to be certain that the coding system be used consistently. A certain degree of artistic skill is required in selecting the most appropriate colour for each design element 25 and at this point, reference may be made to the original graphic design used to create line drawing 50.

Once the first paper version of line drawing 50 has been marked in the manner describe above, sections 96 on the second vinyl version of line drawing 50 are marked in the same manner, ensuring that baselines H′ are clearly marked and that numbers 85 are oriented in accordance with vertical line V in exactly the same manner as on the first paper version of line drawing 50. When marking sections 96 on the vinyl version of line drawing 50, it is important to use a waterproof ink that will not wash off when exposed to water from the cutting saw. The applicant has found that a pen commonly known as a waterproof SHARPIE™ uses ink that is particularly advantageous for this purpose.

Those skilled in the art will appreciate that other similar methods of marking sections 96 defined by cut lines 55 and 55a could be devised that will provide the same advantages as the preferred method described above and used by the applicant. For example, in an alternative method shown in FIG. 10, a pointer 86, having a baseline H″ and a shaft V″, is marked on each section 96. Baseline H″ of pointer 86 is oriented parallel to horizontal line H that was marked on the paper version of line drawing 50 during the marking of background elements 20, and shaft V″ is oriented parallel to vertical line V. In this alternative method, the orientation of design element 25 within void 80 is determined by reference to the orientation of pointer 86 with respect to horizontal line H and vertical line V. In this alternative method, sections 96 are sequentially numbered in the same manner as described above, however, in this method it is not necessary to vertically orient numbers 85. Horizontal line H″ combined with shaft V″ and the sequence of numbers 85 will assist in locating and orientating the corresponding design element 25 within void 80 during final assembly as described in more detail below.

Next, depending on the colour and plan form shape of each design element 25, the type of material to be used for each element is selected. Design elements 25 having an unusual plan form shape will require special materials. For example, long thin design elements 25 will need to be cut from elongated curb material rather than rectangular bricks, assuming that curb material of the desired colour is available. The selection of paving bricks and stones is generally made from rectangle, square, or oval pavers, and curbs or caps. In some cases, if the particular desired material is thicker than that of the required design elements 25, it will be necessary to trim, or “slab”, the material to the required thickness.

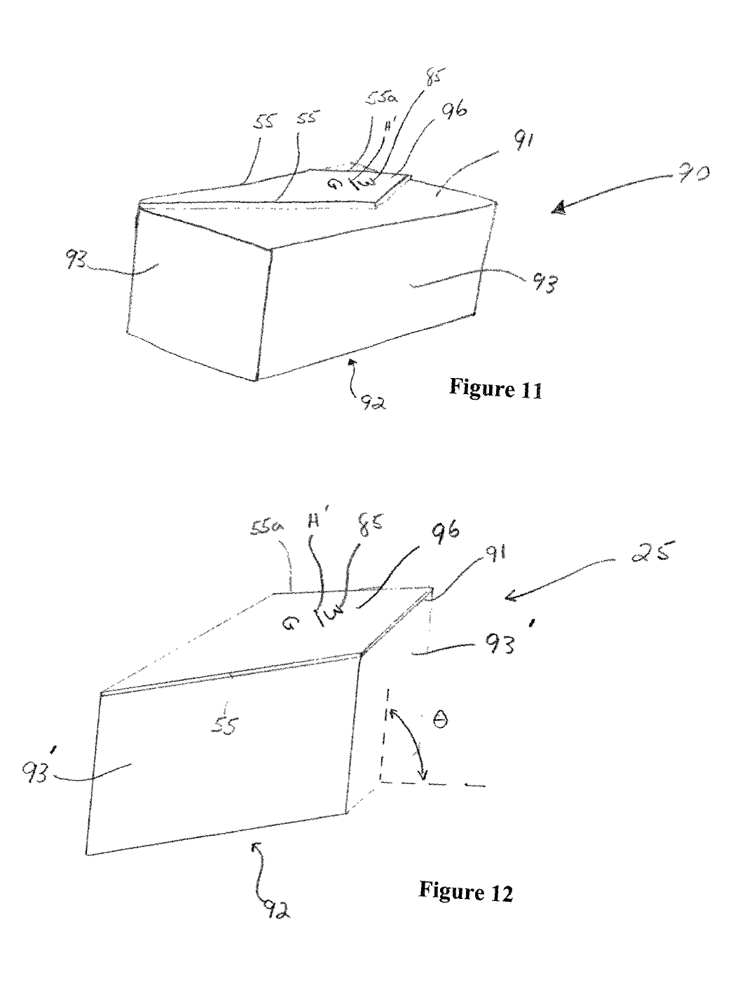

FIG. 11 shows a typical rectangular blank paving stone or brick 90, having a top surface 91, a base 92, and side surfaces 93. Typically, top surface 91 is parallel to base 92 and perpendicular to side surfaces 93. Once the required sizes, colours and textures of paving stones or bricks 90 are selected, they are cleaned, dried and kept at a temperature of at least 60 degrees Fahrenheit (F). Each stone or brick 90 is preheated with a heat gun to about 100 F. Vinyl sections 96, corresponding to the plan form shape of design elements 25 as defined by cut lines 55 and 55a, are removed from the backing sheet of the vinyl version of line drawing 50 and carefully adhered to top surface 91 of the appropriate colour and texture of paving stone in accordance with the coded markings placed on each vinyl section 96. The adhesive backed vinyl sections 96 are secured to paving stones or bricks 90 with pressure using a flexible pressure pad. The applicant has found that a tennis ball is particularly advantageous for this purpose as it allows sufficient pressure to be evenly and accurately applied. The combination of pressure from the pressure pad and heat from paving stone 90 results in a secure adhesion of vinyl sections 96 to paving stones 90. It is important that the vinyl sections completely and securely adhere to the paving stones and that they continue to remain adhered during the cutting process which may use water directed toward the paving stones at high pressure. Vinyl sections 96 are arranged on paving stones 90 in a manner that will make the most efficient use of the paving materials available and provide as little waste as possible, while at the same time allowing for efficient cutting of design elements 25.

Once all vinyl sections 96 have been affixed to the appropriate colours and sizes of paving stones 90, cutting is commenced using saw 70, or any other suitable saw, by carefully following the exterior edges of vinyl sections 96 which correspond to cut lines 55 and 55a on line drawing 50 and define the plan form shape of design elements 25. FIG. 12 illustrates a typical design element 25 after cutting. Design element 25 includes top surface 91, base 92 and cut side surfaces 93′. Referring to FIG. 12, the following are some examples of the various cutting techniques that are use when cutting design elements 25:

Straight Cuts: saw blade 75 is held vertical to side surfaces 93 of paving stone 90 and a cut is made along cut lines 55 or 55a. In this case, the resulting angle θ between cut side surface 93′ and base 92 is 90 degrees;

Acute Angle Cuts: paving stone 90 is held so that saw blade 75 is at an acute angle θ with respect to base 92. The result is that on installation, the point of contact between adjacent elements is at or near the upper surface 91 permitting easy of fitting design elements 25 together and precise control of the visual effect of the joints between the elements. Moreover, acute angle cuts allow design elements 25 to accommodate some curvature or unevenness in the underlying substrate without significantly disrupting the design. The resulting angle θ can be any convenient value commensurate with strength and stability considerations of the element when installed. Typically, an angle θ of approximately 87 degrees has been found by the applicant to be satisfactory, although smaller angles can be used;

V-notch: when cutting a v-notch, the front edge of circular saw blade 75 at surface 91 will be ahead of the front edge of blade 75 at base 92. Therefore it is necessary to rotate stone 90 backward against the blade to fully cut base 92 so as to match the plan form shape of surface 91. This technique requires hand rolling the paving material and is one reason why the applicant uses a smooth diamond-edged saw blade. Hand rolling the material while cutting would be extremely dangerous with a toothed blade.

Scarving inside fillets—circular saw 70 is only capable of cutting straight lines, however, fine angles and curves can be cut by repeatedly running saw blade 75 perpendicular to surface 91;

Scarring surface—in some cases, where design elements 25 of the same colour are to be placed side by side, it is not necessary to cut through the entire stone to produce the desired design effect on surface 91. In these situations, selected cut lines 55 and 55a are merely traced by using the saw blade to scar surface 91 to a depth of a few millimeters. The combined design element 25 can then be set into void 80 as a single unit, aiding in assembly.

Once design elements 25 are cut they can be place into their designated positions within void 80. The location and orientation of each design element 25 is determined quickly by reference to number 85 and baseline H′ marked on vinyl sections 96 which remain adhered to design elements 25 during and after the cutting process. The sequence of number 85 indicates generally the location of each design element 25 within void 80, while the orientation of number 85 and baseline H′ indicates the orientation of each design element 25. Each design element 25 is placed within void 80 oriented such that baseline H′ is parallel to horizontal line H and the vertical axis of number 85 is parallel to vertical line V. Using the cues provided by number 85 and baseline H′, design elements 25 can be quickly and easily assembled within void 80. Without such markings, it would be difficult and extremely time consuming to assemble design elements 25 so as to reproduce design 30. The convenient marking of each vinyl section 96 to correspond with the location and orientation of each design element 25 within void 80 means that all design elements 25 can be cut before any assembly takes place. This speeds the cutting process and greatly improves efficiency during assembly of the final design.

Typically, once all design elements 25 have been properly assembled into void 80 within background elements 20, vinyl sections 96 are removed and surface 91 is washed and cleaned with muriatic acid and left to dry. Two coats of sealer are applied and crate 60 is sealed by first folding flaps 64 of fabric 62 up to cover and protect the surface of covering material 10 and then attaching a suitable lid. If necessary, tie straps can be used to securely bind crate 60 for shipping.

After transportation to the work site, installation of covering material 10 within surrounding matrix 40, conveniently proceeds as follows:

a) crate 60 is opened and set next to the corresponding opening left in the prepared surrounding matrix 40;

b) flaps 64 of fabric 62 are unfold and used as hand grips to lift and remove covering material 10 from crate 60 as a single integral unit;

c) covering material 10, supported by fabric 62, is carefully placed into the opening in surrounding matrix 40;

d) any necessary minor adjustments are made to elements 20 and 25;

d) flaps 64 are cut away and stabilizing sand is swept into the crevices between elements 20 and 25. If machine compacting is necessary, the lid of crate 60 can be used to protect covering material 10 and prevent any damage to image 30.

One additional advantage of the method of the present invention is apparent in the reproduction of very large designs which, because of their size, can not be accommodated within a single crate. In these situations, the applicant has often found it necessary to package and ship all or a portion of design elements 25 in crates separate from background elements 20. In these situations, vinyl sections 96 are left in place on design elements 20 to aid in the final positioning of design elements 20 into their on-site locations within surrounding matrix 40.

The invention described herein may be embodied in other specific forms without departing from the spirit or essential characteristics thereof. The present embodiments are therefore to be considered as illustrative and not restrictive, the scope of the invention being indicated by the appended claims rather than by the foregoing description, and all changes that come within the meaning and range of equivalency of the claims are therefore intended to be embraced therein.

The embodiments of the invention in which an exclusive property or privilege is claimed are defined as follows:

1. A method of manufacturing a covering material for covering a substrate, the covering material including a complex visual design, comprising the steps of:
selecting the design for the covering material;
creating a plurality of design sections, each said design section corresponding to a distinct predetermined area of structure and colour of the design, each said design section having a predetermined orientation and location within the design, and each said design section defining a predetermined plan form shape,
marking said design sections to identify said predetermined colour, orientation and location;
selecting blank elements of various colours, said colours corresponding to said identified predetermined colours of said design sections, said blank elements having an arbitrary predetermined shape;
manufacturing design elements from said blank elements by:
selecting a surface of each of said blank elements as defining an upper design surface of each of said design elements;
corresponding said identified predetermined colours of said design sections with said corresponding colours of said blank elements and fixing said corresponded design sections to said upper design surfaces of said corresponding colours of said blank elements; and
cutting said blank elements to form said design elements, said upper design surface of each said resulting design element having a plan form shape corresponding to said plan form shape of said affixed design section;
preparing background elements having a void sufficient to accommodate said design elements;
assembling said design elements into said void in an inter-engaging relationship in accordance with said identified orientations and locations marked on said affixed design sections; and
removing said design sections from said design elements.

2. The method of claim 1, wherein said design sections are made of adhesive-backed vinyl.

3. The method of claim 1, wherein said design sections are marked with a water-proof ink.

4. The method of claim 1, wherein said predetermined orientation within the design is both a vertical orientation and a horizontal orientation.

5. The method of claim 1, wherein said predetermined location within the design is a sequential location.

6. The method of claim 1, wherein said plurality of design sections are created by first producing a line drawing representative of the design, said line drawing comprising exterior lines defining a plan form shape of the design, and interior lines, said interior and exterior lines combining to define said design sections.

7. The method of claim 6, wherein said line drawing is produced from a digital representation of the design produced by electronically scanning the design into a computer.

8. The method of claim 1, wherein the preparation of said background elements includes the steps of:
arranging onto a support structure a plurality of inter-engaged background elements covering an area sufficient to accommodate the design, said background elements comprising substantially planar, substantially parallel top and bottom surfaces, and one or more background element side surfaces connecting said top and bottom surfaces;
marking background cut lines onto said top surfaces of said inter-engaged background elements, said background cut lines corresponding to a plan form shape of the design;
cutting said background elements along said background cut lines to redefine one or more of said background element side surfaces;
removing said cut background elements corresponding to said plan form shape of the design, thereby creating a void within said inter-engaged background elements, said void corresponding to said plan form shape of the design;

9. The method of claim 8, wherein said support structure is a crate having a bottom, one or more sides and a lid.

10. The method of claim 9, wherein when the covering material is to be used as ground cover, said support structure includes a separation layer of suitable fabric or paper between said crate bottom and said background elements.

11. The method of claim 1, including the step of heating said blank elements to a temperature on the order of 100 degrees Fahrenheit prior to affixing said design sections.

12. The method of claim 1, wherein said resulting design elements have a base, said base being substantially planar and substantially parallel to said upper design surface, and one or more design element side surfaces, said design element side surfaces being oriented at an acute angle with respect to said base.

13. The method of claim 12, wherein said acute angle is approximately 87 degrees.

14. The method of claim 1, wherein the substrate is a ground surface.

15. The method of claim 1, wherein the substrate is a wall.

16. The method of claim 1, including the steps of applying a sealer to said upper design surfaces of said resulting design elements following the removal of said design sections.

17. The method of claim 1, including the further steps of package the covering material in a crate for shipping to a remote location.

18. A method of manufacturing a covering material for covering a substrate, the covering material including a complex visual design, comprising the steps of:
selecting the design for the covering material;
creating a line drawing representative of the design, said line drawing comprising a plurality of design sections, each said design section corresponding to a distinct predetermined area of structure and colour of the design, each said design section having a predetermined orientation and location within the design, and each said design section defining a predetermined plan form shape;
marking said design sections to identify said predetermined colour, orientation and location;
selecting blank elements of various colours, said colours corresponding to said identified predetermined colours of said design sections, said blank elements having an arbitrary predetermined shape;
manufacturing design elements from said blank elements by:
selecting a surface of each of said blank elements as defining an upper design surface of each of said design elements;
corresponding said identified predetermined colours of said design sections with said corresponding colours of said blank elements and fixing said corresponded design sections to said upper design surfaces of said corresponding colours of said blank elements; and
cutting said blank elements to form said design elements, said upper design surface of each said resulting design elements having a plan form shape corresponding to said plan form shape of said affixed design section;
preparing background elements having a void sufficient to accommodate said design elements;
assembling said design elements into said void in an inter-engaging relationship in accordance with said identified orientations and locations marked on said affixed design sections; and
removing said design sections from said design elements.

19. A method of manufacturing a covering material for covering a substrate, the covering material including a complex visual design, comprising the steps of:
selecting the design for the covering material;
creating a line drawing representative of the design, said line drawing comprising exterior perimeter lines defining a plan form shape of the design, and interior lines, said interior and exterior lines combining to define a plurality of design sections, each of said design sections corresponding to a distinct predetermined area of structure and colour of the design, each of said design sections having a predetermined orientation and location within the design, and each of said design sections defining a predetermined plan form shape;
marking said design sections to identify said predetermined colour, orientation and location;
arranging onto a support structure a plurality of inter-engaged background elements covering an area sufficient to accommodate the design, said background elements comprising substantially planar, substantially parallel top and bottom surfaces, and one or more background element side surfaces connecting said top and bottom surfaces;
marking background cut lines onto said top surfaces of said inter-engaged background elements, said background cut lines corresponding to said exterior perimeter lines of the design;
cutting said background elements along said background cut lines to redefine one or more of said background element side surfaces;
removing said cut background elements corresponding to said plan form shape of the design, thereby creating a void within said inter-engaged background elements, said void corresponding to said plan form shape of the design;
selecting blank elements of various colours, said colours corresponding to said identified predetermined colours of said design sections, said blank elements having an arbitrary predetermined shape;
manufacturing design elements from said blank elements by:
selecting a surface of each of said blank elements as defining an upper design surface of each of said design elements;
corresponding said identified predetermined colours of said design sections with said corresponding colours of said blank elements and fixing said corresponded design sections to said upper design surfaces of said corresponding colours of said blank elements; and
cutting said blank elements to form said design elements, each of said resulting design elements having a base, said base being substantially planar and substantially parallel to said upper design surface, and one or more design element side surfaces, said design element side surfaces being oriented at an acute angle with respect to said base and cooperating to define said upper design surface, said upper design surface having a plan form shape corresponding to said plan form shape of said affixed design section;
assembling said design elements into said void in an inter-engaging pattern in accordance with said identified orientations and locations marked on said design sections; and
removing said design sections from said design elements.

20. A covering material for covering a substrate, the covering material including a complex visual design, said covering material produced by the method of claim 1.
